(19) United States
(12) Patent Application Publication
(10) Pub. No.: US 2016/0262349 A1
(43) Pub. Date: Sep. 15, 2016

(54) Hoof Bandage Sock

(71) Applicant: Jeannette Swearingen, Huntsville, AL (US)

(72) Inventor: Jeannette Swearingen, Huntsville, AL (US)

(21) Appl. No.: 15/072,321

(22) Filed: Mar. 16, 2016

Related U.S. Application Data
(63) Continuation-in-part of application No. 13/882,202, filed on Apr. 29, 2013, now abandoned.
(60) Provisional application No. 62/133,509, filed on Mar. 16, 2015.
(60) Provisional application No. 61/408,615, filed on Oct. 31, 2010.

(51) Int. Cl. A01K 13/00; A01L 15/00

(52) U.S. Cl. CPC A01K 13/007; A01L 15/00; B05D 1/02

(57) ABSTRACT

A one piece hoof bandage sock for use with horses and other hoofed animals includes an elastic sock material and a flexible, protective plastic bandage. The bandage covers the sole of the hoof and extends up the wall of the hoof but does not contact the coronet band. The bandage sock stays in place without the use of tapes, wraps, straps, or other fasteners.

### CROSS-REFERENCE TO RELATED APPLICATIONS

This application is a nonprovisional application of U.S. 62/133,509 filed Mar. 16, 2015 and a Continuation-in-part of U.S. Ser. No. 13/882,202 filed Apr. 29, 2013. U.S. Ser. No. 13/882,202 is a national stage entry of PCT/U.S. 11/585481 filed Oct. 29, 2011, which claims priority to U.S. 61/408,615, filed Oct. 31, 2011.

### BACKGROUND OF THE INVENTION

1. Field of the Invention

The present invention relates generally to the treatment and prevention of hoof ailments and injuries on hoofed animals. Specifically, the invention includes a hoof bandage sock, methods for its manufacture, and a method for protecting the hoof of an animal.

2. Description of Related Art

Equine hoof ailments such as abscesses, punctures and stone bruises are common and can be painful, recurring, and debilitating. If not properly tended, a hoof injury can lead to death. Hoof injuries should be kept clean and and protected from further injury in order to prevent infection and promote healing. This is most frequently accomplished using bandages that must be changed frequently and/or by specialised hoof coverings secured to the hoof by securing means such as straps, bands, clamps, and adhesives.

The coronet band, or coronary band, is an area of tissue above the hoof containing the germinal cells from which hoof tissue is formed. This area can be particularly sensitive to injury by pressure, chafing, or laceration caused by tapes, wraps, securing means, or edges of hoof covering materials. Removing and applying adhesive or elastic tape often requires a skilled person to hold the horse's hoof up long enough to remove the bandage or covering, clean area, apply and new bandage or covering, and apply fresh tape. Elastic wrapping tape can roll up or unravel if not applied correctly and can impair blood circulation if applied too tightly. Removal of duct tape requires cutting with sharp edges, which can be hazardous to the caregiver and the animal and can also injure the skin if the tape is adhered to hair or bare skin. Removal of elastic wrapping tape is time consuming and, if done improperly, can contaminate a wound or lesion. Adjustable bands and straps apply pressure to hold hoof coverings such as hoof boots in place. These securing means and their buckles can can interfere with blood circulation and cause chafing against the fetlock or coronet band, resulting in injury.

Many hoof covering devices, including hoof boots, have been described for protecting the hooves of horses and other animals.

U.S. 2016/0029609 describes an equine hoof boot that can be used as a replacement for metal horse shoes. The boot is held in place by one or more straps that tighten around the hoof and a collar that fits on or above the coronary band of the hoof. U.S. Pat. No. 7,578,115 describes a protective hoof boot comprising a boot shell connected to a protective gator that wraps around the pastern to secure the back of the boot shell in position on the hoof. The boot shell has a tongue that allows the shell to be open for application to the hoof and an elastic strap to hold the shell in a closed position to secure the shell on the hoof. U.S. Pat. No. 7,445,051 describes an equine hoof boot, boot pad, and pad assembly designed to protect the hoof while healing from laminitis. The boot has a body, closure straps, and sole plate. The height of the boot from the sole to the top is sufficient to clear the hoof so the boot top can be secured around the leg above the coronary band and the bulbs of the heel. Fasting means at the front and rear of the boot top are tightened to secure the boot to the leg. U.S. 2012/0180441 describes a hoof boot having a sole with lugs that allows an animal to easily move through loose soils such as sand and mud. The hoof boot is attached to the hoof using a strap or an adhesive. U.S. Pat. No. 6,560,951 describes a flexible boot for use with livestock. The boot comprises a wall having a fastening element with flexible non extensible straps and reversible hook and eye fastener elements for attaching the boot to the hoof and leg. The boot comprises a resilient and extensible wall having the shape of a truncated cone having a height sufficient to cover the hoof up to the coronet.

U.S. 2007/0068125 describes a hoof treatment device comprising a protective, flexible boot that fits over and covers a hoof, and includes a pad insert that can receive a medicine. The lower portion of the boot covering the sole is connected to an upper portion that covers the animal's leg above the cornet band. Straps on the upper portion above the coronet are tightened to hold the boot in place. U.S. 2007/0039289 describes an equine hoof boot made of an elastic boot material with hoof wall and sole portions that are elastically stretched to hug the wall and heel of the hoof. When fitted on the hoof, a proximal terminus of the boot is adjacent to the coronary band. To avoid damaging the coronary band, the boot is made of rubber or similar an elastic material.

Each of the aforementioned devices provides one or more advantages for protecting a hoof. None of the devices, however, provide for a hoof bandage that protects the hoof without risk of damage to the leg or coronary band or interfering with blood circulation while being easy to apply and remove. The hoof bandage sock described herein improves upon the existing devices and satisfies the continuing need for a hoof bandage sock that protects the hoof from injury and contamination, can be applied and removed quickly and easily, and does not risk damaging the leg or the coronet band or reducing blood circulation to the hoof.

### BRIEF SUMMARY OF THE INVENTION

In one aspect, the present invention provides for a hoof bandage sock. The hoof bandage sock is embodied as a one-piece construction that is configured to receive the hoof and a portion of the lower leg of the animal. The bandage sock comprises an elastic sock material and a bandage portion comprising a portion of the sock material and a hoof-shaped plastic bandage material integrated with the sock material. The inventor has unexpectedly found that no additional fasting means such as tapes, wraps, straps, or bands are required for the hoof bandage sock to stay on the hoof for prolonged periods of time.

In another aspect, the invention provides for methods for manufacturing a hoof bandage sock. The method involves placing one end of an elastic sock on a hoof-shaped model; applying a fluid plastic material to the bottom end of the elastic sock; curing the fluid plastic material to form a solid plastic material; and removing the resulting elastic sock with attached plastic material from the hoof-shaped model.

In yet another aspect, the invention provides a method for covering an injured or diseased animal hoof comprising the application of a hoof bandage sock to the hoof and leg of an animal.

Reference is made to examples involving a horse and horse hoof to describe the invention. The invention, however, is not limited to horses and horse hooves but can also be embodied as a bandage sock for other hoofed animals such as miniature horses, ponies, donkeys, mules, cows, bison, goats, sheep, pigs, llamas, alpacas, camels, zebras, giraffes, and deer.

### BRIEF DESCRIPTION OF THE DRAWINGS

Like reference numerals are intended to identify the same structural elements, portions, or surfaces consistently throughout the drawings. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), refer to the orientation of the illustrated structure as the particular drawing figure faces the reader. “Proximal” and “distal” have their normal meanings as used in anatomy and physiology.

FIGS. 1 and 2 show side and cross-section views of a first embodiment of a hoof bandage sock covering a hoof and extending up the leg to the pastern;

FIGS. 3A-D are views of different embodiments of a hoof bandage sock that has not been placed on a hoof; and

FIGS. 4A-E are top views of different embodiments of a reinforcing sheet that may be present in the sole of a hoof bandage sock.

### DETAILED DESCRIPTION OF THE INVENTION

A hoof bandage sock for treating and preventing wounds and ailments in a hoofed animal is described in WO 2012/058651 A1, which is incorporated by reference. The described hoof bandage sock represents an improvement over earlier hoof and lower leg coverings and does not require the use of duct tape, vet wrap, or straps to hold the bandage in place. The hoof bandage sock comprises a form-fitting, elastic fabric that holds the sock above the hoof, making the placement of the covering on the hoof and leg easier and faster than previous hoof and leg coverings. The light-weight and elastic sock material appears to prevent the wearer from sensing or reacting its presence, which may contribute to prolonged wearing times because the animal is less likely to attempt removing the bandage.

As used herein, a sock is a garment for covering the hoof and lower part of the leg of a hoofed animal. An elastic sock is material may be a knitted, braided, non-woven, or woven fabric that is able to resume its normal shape spontaneously after being stretched. A fabric is made of fibers or strands of material. An “open tubular sock” refers to a sock that is not sewn closed at either end. A “closed tubular sock” refers to a tubular sock that is sewn closed at one end and is open at the other end.

“To permeate” is used herein in the context of a fluid plastic material and an elastic sock material to indicate soaking or seeping of the fluid plastic between strands or fibres that comprise the sock material and thereby into the fabric of the elastic sock material. When a fluid plastic material is cured after permeating an elastic sock material, the plastic material and the elastic sock material become integrated.

A “plastic,” as used herein, is a synthetic material made from any of a wide range of polymers that can be moulded into shape while soft or fluid, and then set into a solid form. A fluid plastic does not hold its shape and can flow and be shaped. A solid plastic holds its shape. A flexible solid plastic is a solid plastic that can bend without breaking.

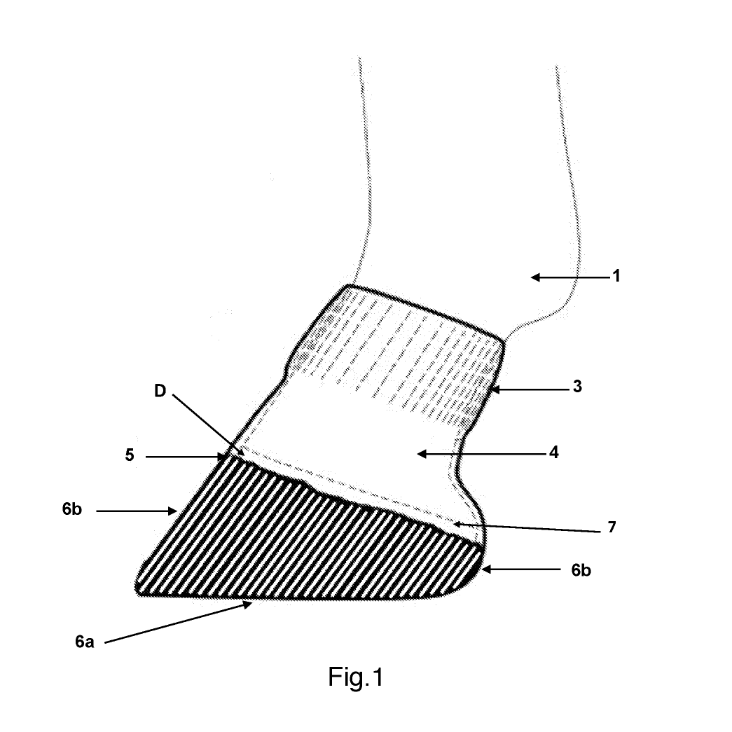

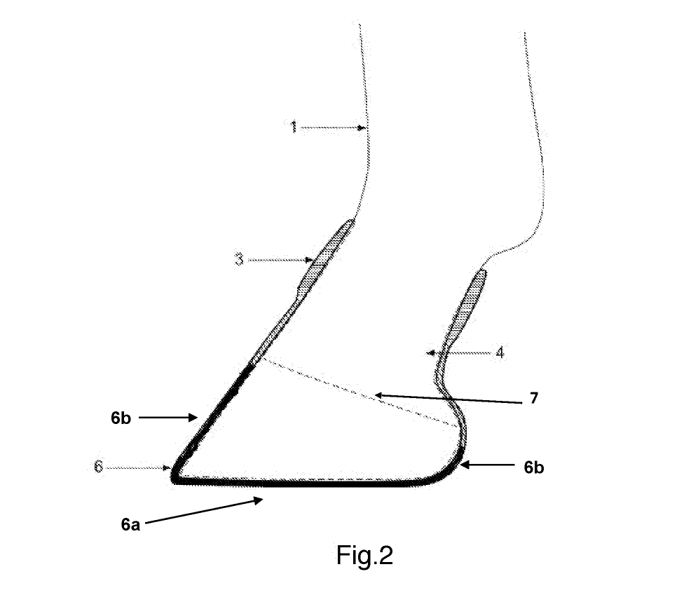

FIGS. 1 and 2 show a first embodiment of a hoof bandage sock on the leg 1 of a horse. The hoof bandage sock comprises an elastic sock material 4 configured to cover the leg 1 from the pastern down. In other embodiments, the sock may be longer or shorter to cover more or less of the leg. The elastic sock is preferably made from a water repelling or waterproof fabric and may comprise, for example, one or more of cotton, polyester, acrylic fibers, nylon, lycra, latex, spandex, a polyester-polyurethane copolymer, and a para-aramid polymer. In a preferred embodiment, the elastic sock material comprises fibres of poly-paraphenylene terephthalamide. The elastic sock material may be selected to provide 360 degrees uniform compression. The proximal, or upper section of the sock is open and may comprise a cuff 3 having a greater thickness and/or stiffness than the rest of the sock material. For example, the cuff 3 may be a region of knitted or braided fabric and be sized to provide a compression force over a broad area that is sufficient to prevent the sock from sliding down the leg. The length of the cuff 3 may, for example, be between 2 and 5 inches. A distal, or lower end of the elastic sock 4 may be open, partially open, or completely closed.

The lower end portion of the bandage sock comprises a flexible plastic bandage 6. The bandage 6 is flexible, durable and waterproof and is shaped to receive and cover the sole of the hoof and a portion of the wall of the hoof below the coronet band 7. The protective bandage 6 comprises a hoof sole covering portion 6a and a hoof wall covering portion 6b that extends upward from the sole covering portion. The protective bandage 6 is configured to cover all of the sole and at least the bottom 1 cm of the heel or posterior wall and the bottom 1 cm of the front or anterior wall of the hoof in a continuous pattern. In a preferred embodiment, protective bandage 6 is configured to cover all of the sole and at least the bottom 2 cm of the heel or posterior wall and the bottom 4 cm of the front or anterior wall of the hoof in a continuous pattern. In a more preferred embodiment, the bandage covers all of the hoof wall that is more than a set distance from the coronary band 7. In an alternative embodiment, the protective bandage 6 may be configured to cover the hoof wall in a discontinuous pattern. The front of the hoof wall is typically longer than the heel of the hoof and, in preferred embodiments, the wall covering portion 6b at the heel extends a relatively smaller distance from sole covering portion than the wall covering portion at the toe, or front of the bandage 6. The wall covering portion 6b at the back of the bandage angles radially outward from sole covering portion 6a, which is helpful for placing the bandage on the hoof as the toe portion the hoof maybe received by the bandage first and heel portion may be positioned over the heel of the hoof wall after.

The bandage sock is configured such that, when placed on a hoof, no part of the bandage 6 contacts the coronet band. This prevents the solid plastic material of the bandage from chafing or abrading the coronet band or other soft tissues above the hoof. This feature can be accomplished by placing a properly sized hoof bandage sock on the hoof such that, when placed in the hoof of the animal, a top edge 5 of the bandage is located at a set distance D from the coronet band 7. Examples of the set distance D include 2 mm, 5 mm, 7.5 mm, and 1 cm from the coronet band 7. The top edge 5 of the bandage 6 may be configured to be a distance D form the coronet band that is constant around the circumference of the hoof. The top edge 5 of the bandage 6 may alternatively be configured to have a variable distance D around the circumference of the hoof such that the distance D is greater at the from portion of the bandage than at the back of the bandage. The thickness of the bandage 6 is preferably between 1 mm and 5 mm. The thickness and/or composition of the bandage may also be variable along a dimension of the bandage. In one embodiment, for example, the thickness and/or composition of the plastic material is variable with the height of the coating along the hoof wall. Additionally or alternatively, the thickness and/or composition of the plastic material is variable along the sole covering portion 6a.

Plastic materials that may be used include one or more of: a natural rubber, a synthetic rubber, a polyurethane, an aromatic polyurethane, a polyurea, an aromatic polyurea, a polyphenylene sulfide, a polystyrene, an epoxy resin, a polyphenol, a polytetrafluoroethylene, a polymethylelene, a polyimide, a polyamide-imide, nylon, a polyetheretherketone, a polyethylene, a nitrile (acrylonitrile butadiene) polymer, a hybrid polyurethane/polyurea, and a polyeteramine. In a preferred embodiment, the coating material comprises a fast curing hybrid polyurethane/polyurea polymer.

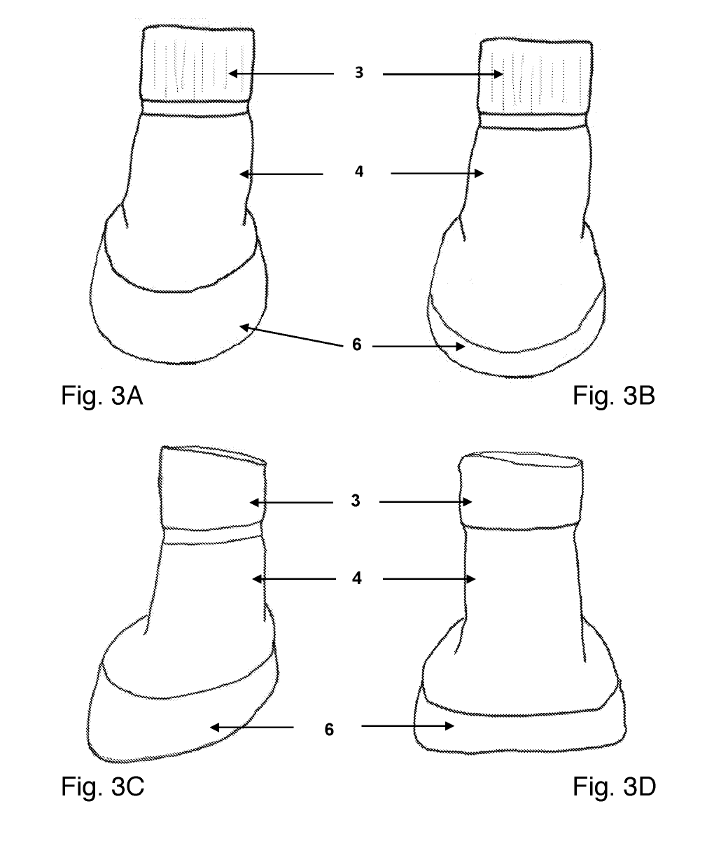

FIGS. 3A-D show four different embodiments of hoof bandage socks. FIG. 3A is a front view of a first embodiment in which the upper portion of the sock material comprises a cuff 3 and the bandage 6 is configured to extend over most of the hoof wall at the toe below the coronet band. FIG. 3B is a front view of a second embodiment in which the upper portion of the sock material comprises a cuff 3 and the bandage 6 is configured to extend over a relatively smaller portion of the hoof wall at the toe than the first embodiment. FIG. 3C is a side view of a third embodiment in which it can be seen that the bandage 6 extends further from the sole at the front than at the back. FIG. 3D is a back view of a fourth embodiment in which the upper sock portion comprises a cuff 3. The sock portions shown in FIGS. 3A-C each comprise three sections having different exterior diameters in the relaxed, non-stretched state. The sock portion shown FIG. 3D comprises two sections having different exterior diameters. The portions having different diameters may have different elasticities and provide different compressive forces to the leg. The compressive forces are distributed over a wider area than the types of belts, bands, or straps used in existing hoof boot devices and do not risk damaging the leg or impairing circulation.

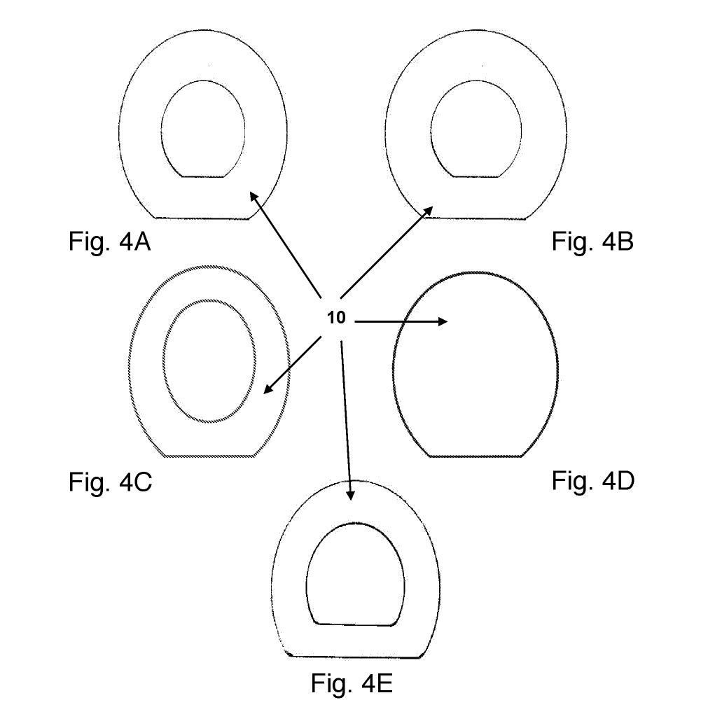

The sole covering portion 6a of the bandage may comprise a reinforcing sheet 10 to improve the durability of the sole covering portion 6a and/or to improve puncture resistance. The reinforcing sheet 10 may have a horse shoe shape, a solid disc shape, a doughnut shape, or other suitable shape that allows the reinforcing pad to be positioned along the weight bearing portions of the hoof. The reinforcing sheet 10 may be positioned inside the sole covering portion 6a of the bandage 6 and configured to be in contact with the hoof sole. Alternatively, the reinforcing sheet 10 may be positioned on the outside of the sole covering portion 6a and configured to contact the ground. The reinforcing sheet 10 may also be positioned inside the sole covering portion 6a of the bandage 6 between the sock material and the plastic material. Examples of reinforcing sheet shapes are shown in FIGS. 4A-E. The shape and number of reinforcing pads may be adapted for different hoof shapes of different species of hoofed animal. The reinforcement sheet is preferably from about 0.5 mm to about 2 mm thick and more preferably about 1 mm to about 1.5 mm thick. The reinforcing pad may comprise, for example, woven or nonwoven natural fibers, polymers, resins, or composites. In one preferred embodiment, the reinforcing pad comprises a high density nylon weave. In another preferred embodiment, the reinforcing pad comprises a woven natural yarn and a nonwoven sheet rubber type material. Natural woven fibers may include abaca, coir, cotton, wool, flax, hemp, jute, silk, sisal, ramie, and bamboo. In another preferred embodiment, the reinforcing pad comprises a woven or nonwoven synthetic yarn and a nonwoven sheet rubber type material. Examples of man-made fiber yarns include polyester, acrylic, nylon, rayon, acetate, spandex, latex and Kevlar. Embodiments comprising nonwoven sheet rubber type material may comprise recycled post consumer tires and/or natural and/or synthetic rubber.

A method for making a hoof bandage sock comprises the steps of placing the bottom end portion of the elastic sock on a hoof-shaped model; applying a fluid plastic material to the bottom end of the elastic sock such that the fluid plastic material permeates bottom end of the elastic sock; curing or hardening the fluid plastic material to form a solid plastic material, at least a portion of which permeates the bottom end of the elastic sock and forms a bandage at the bottom of the sock material; and removing the elastic bandage sock from the hoof-shaped model.

In a process for making an improved hoof bandage sock, the elastic sock is placed on a model of a hoof. Models of different sizes and shapes may be used to produce hoof bandage socks of different sizes for different species of hoofed animal. For the making of a horse hoof bandage sock, a hoof shaped model comprises a solid material comprising a hoof portion having the shape of a horse hoof and a leg portion having the shape of a horse leg extending above the hoof. In a preferred embodiment, the leg portion extends at least 2.5 cm above the hoof portion with the boundary between the hoof and leg portions corresponding to the coronary band. The model may be made, for example, by scanning a single horse hoof and lower leg to collect data to be used by a 3-D printer to produce the model. Alternatively, a plurality of horse hooves and lower legs having the same size hoof is scanned to generate an averaged shape for a horse hoof and lower leg. The averaged hoof/lower leg shape is then used for 3-D printing of an averaged hoof/lower leg model of a hoof of a particular size. Standard equine hoof sizes range from size 000 to size 8. Larger or smaller hood sizes may also be used. Hooves/lower legs of other hoofed animals can be used for making hoof bandage socks of other hoofed animals such as miniature horses, ponies, donkeys, mules, cows, bison, goats, sheep, pigs, llamas, alpacas, camels, zebras, giraffes, and deer. As an alternative to scanning and 3-D printing, hooves/lower legs may be used to produce casts and moulds for making model hooves/lower legs.

An elastic sock is placed over the model such that the lower end of the sock is positioned on the hoof portion of the model. The lower end of the elastic sock may be closed with the closed end of the elastic sock material positioned on the sole of the hoof portion of the model. Alternatively, the lower end of the elastic sock may be open with the lower end of the sock positioned near the edge where the sole and wall of the hoof meet. It is important that a portion of the lower end of the sock be permeated by fluid plastic material in the subsequent application step so that sufficient integration of sock and plastic occurs to form a bandage that will not separate from the restive the sock.

After the sock is positioned on the model, a fluid plastic is applied to the elastic sock material to form a sole covering portion 6a and a wall covering portion 6b of the bandage 6. The fluid plastic material penetrates into spaces between the stands or fibres of the sock material so that the fluid plastic permeates the sock material. Once the fluid plastic material solidifies by curing or cooling, elastic sock material at the lower end of sock and solid plastic material are integrated and form the bandage 6 of the bandage sock.

The fluid plastic may be applied by spraying or dipping, which may be performed manually or using an automated system. For manual application, marker lines may be used to indicate where the upper edge 5 of the coating material 6 is to be located. A wire may be wrapped around the sock at the position of the upper edge 5 to facilitate removal of any over-dip or over-spray that results in the deposition of coating material above the intended upper edge. Automated dipping or spraying systems may be programmed to apply the fluid plastic material to provide the set distance D between the coronet band on the hoof model and the upper edge 5 of the bandage. Applying the fluid plastic material may comprise injecting the fluid plastic material into a space between the hoof-shaped model and a moulding surface arranged at a distance around the outside of the model. The moulding surface may be at a fixed distance from the model such that the fluid plastic material fills the space between the model and the moulding surface. Alternatively, the moulding surface may be movable and press against the fluid plastic material after it is applied to the elastic sock material.

The fluid plastic material may comprise one, two, or more separate components that are mixed immediately before application and which react chemically to form a cured, solid plastic material. In another embodiment, the fluid plastic material may comprise a heated plastic which, upon cooling, hardens to form a solid plastic material. In a preferred embodiment, the fluid plastic material comprises two components mixed immediately before being sprayed onto the sock material for form a fast curing hybrid polyurethane/polyurea polymer. Fast curing hybrid polyurethane/polyurea polymer systems are used commercially and are available through Line-X® and Rhino Linings®, for example.

A liner made of plastic sheeting or similar material may be placed over the model before the sock is drawn onto the model to facilitate removal of the bandage sock after the plastic material cures, stiffens, or hardens to the point where the coating material will hold the shape of the portion of the model over which it is applied.

A reinforcing sheet 10 may be placed onto the sole of the model hoof before placing the sock on the model so that the reinforcing sheet is affixed to the inside of the sock by the plastic material that penetrates through the sock material. Alternatively or additionally, a reinforcing pad may be placed onto the portion of the sock covering the sole of the model hoof so that the reinforcing pad is affixed to the outside surface of the sock material and covered by the plastic material. Alternatively or additionally, a reinforcing pad may be placed onto the portion of the coating material covering the sock on the sole of the model hoof before the coating material completely dries or cures so that the reinforcing pad is affixed to the coating material on the outside surface of the coating material.

After the fluid plastic material cures to form a solid plastic material, the finished hoof bandage sock is removed from the model.

The invention has been described with the aid of drawings and examples, the use of which is not intended to limit the scope of the invention. The description is not intended to be exhaustive or to limit the invention to the form disclosed, and many modifications and variations are possible.

1. A bandage sock for covering a hoof and a portion of a leg of an animal, said hoof comprising a hoof sole and a hoof wall, wherein the bandage sock comprises:
an elastic sock having an open upper end and a lower end and
a plastic bandage that covers and permeates the lower end of the elastic sock, wherein:
the plastic bandage comprises a plastic material that is shaped to receive the sole and a portion of the wall of the hoof;
the plastic bandage comprises a sole covering portion shaped to cover the sole of the hoof and a wall covering portion extending from the sole covering portion and shaped to cover at least a portion of the hoof wall;
the wall covering portion is shaped such that, when the hoof sole covering portion covers the hoof sole, a distance D separates an upper edge of the wall covering portion from a coronary band above the hoof wall such that no portion of the plastic bandage contacts the coronary band; and
the elastic sock extends from the wall covering portion such that the open upper end of the sock may be positioned on the leg of the animal above the hoof such that the elastic sock covers the coronary band and at least portion of the leg above coronary band.

2. The bandage sock of claim 1, wherein the bandage sock consists of the elastic sock, the plastic bandage that covers and permeates the lower end of the elastic sock, and a reinforcing sheet positioned between the elastic sock material and the plastic bandage.

3. The bandage sock of claim 1, wherein the elastic sock is made of a water resistant fabric.

4. The bandage sock of claim 1, wherein the elastic sock comprises a para-aramid polymer.

5. The bandage sock of claim 1, wherein the wall covering portion of the hoof bandage extends at least 1 cm from the sole covering portion to cover at least 1 cm of the hoof.

6. The bandage sock of claim 1, wherein the distance D is at least 0.5 cm.

7. The bandage sock of claim 1, wherein the distance D is variable around a circumference of wall covering portion of the plastic bandage.

8. The bandage sock of claim 1, wherein the plastic material comprises one or more of: a natural rubber, a synthetic rubber, a polyurethane, a polyurea, an aromatic polyurea, a polyphenylene sulfide, a polystyrene, an epoxy resin, a polyphenol, a polytetrafluoroethylene, a polymethylelene, a polyimide, a polyamide-imide, nylon, a polyetheretherketone, and a polyethylene.

9. The bandage sock of claim 1, and further comprising a reinforcement sheet in or on the sole covering portion of the hoof bandage.

10. The bandage sock of claim 9, wherein the reinforcement sheet has a thickness of between 0.5 mm and 2 mm.

11. The bandage sock of claim 9, wherein the reinforcement sheet comprises one or more of: a high density nylon weave, a woven natural yarn, a nonwoven sheet rubber, a woven synthetic yarn, and a nonwoven synthetic yarn.

12. The bandage sock of claim 1, wherein the plastic bandage has a thickness of from 1 mm to 5 mm.

13. The bandage sock of claim 1, wherein the plastic bandage has a variable thickness in which the sole covering portion has a greater thickness than at least a portion of the wall covering portion.

14. The bandage sock of claim 1, wherein the wall covering portion has a thickness that tapers down toward an upper edge of the wall covering portion.

15. A method for manufacturing the bandage sock of claim 1, said method comprising:
placing the bottom end of the elastic sock on a hoof-shaped model;
applying a fluid plastic material to the bottom end of the elastic sock such that the fluid plastic material permeates bottom end of the elastic sock;
curing the fluid plastic material to form a solid plastic material, at least a portion of which permeates the bottom end of the elastic sock; and
removing the elastic sock and plastic material from the hoof-shaped model.

16. The method of claim 15, wherein said applying a fluid plastic material to the bottom end of the elastic sock comprising spraying the fluid plastic material onto the bottom end of the elastic sock.

17. The method of claim 15, wherein said applying a fluid plastic material to the bottom end of the elastic sock comprising dipping the bottom end of the elastic sock into the fluid plastic material.

18. The method of claim 15, wherein said applying a fluid plastic material comprises injecting the fluid plastic material into a space between the hoof-shaped model and a molding surface.

19. The method of claim 15, and further comprising placing a reinforcing sheet onto the lower end of the sock before applying the fluid plastic material to the bottom end of the elastic sock.

20. The method of claim 15, and further comprising placing a reinforcing sheet onto the lower end of the sock after applying the fluid plastic material to the bottom end of the elastic sock but before curing the fluid plastic material to form a solid plastic material.
